(19) United States
(12) Patent Application Publication
(10) Pub. No.: US 2005/0100636 A1
(43) Pub. Date: May 12, 2005

(54) [A Low-Calorie Sports Drink For Physically Active Women That is Fortified with Iron, Calcium and Essential Vitamins for Use in Rehydration and Replacing Electrolytes Lost During Periods of Physical Activity]

(75) Inventors: Richard L. Botteri, Mt. Bethel, PA (US); Megan K. Botteri, Mt. Bethel, PA (US)

Correspondence Address: RICHARD L. BOTTERI, 193 ORCHARD ROAD, MT. BETHEL, PA, 18343, US

(73) Assignees: Megan K. Botteri, Mt. Bethel, PA (US); Richard L Botteri, Mt. Bethel, PA (US)

(21) Appl. No.: 10/605,956

(22) Filed: Nov. 10, 2003

(51) Int. Cl. A23L 1/30

(52) U.S. Cl. 426/72

(57) ABSTRACT

The present invention provides a low-calorie, hypotonic sports drink composition for physically active women that can be administered orally to provide water and electrolytes lost during physical exertion as well as provide essential vitamins and minerals in the form of iron and calcium to physically active women.

### BACKGROUND OF INVENTION

The invention is a low-calorie, hypotonic sports drink and sports drink concentrate for women who are physically active. The drink is useful in providing an energy source as well as in rehydrating and regaining electrolytic balance before, during and after periods physical activity. Further, the drink is fortified with solubilized Calcium, Iron, Vitamin B, C, D, and Prebiotic Fiber, which proves useful in providing essential vitamins and minerals to women who are physically active.

### SUMMARY OF INVENTION

The invention is a low-calorie, hypotonic sports drink and sports drink concentrate for women who are physically active. The drink, is useful in providing an energy source and in rehydrating and regaining electrolytic balance before, during and after periods physical activity and exercise

### DETAILED DESCRIPTION

The invention is a low-calorie, hypotonic sports drink and sports drink concentrate for women who are physically active. The drink, is useful in providing an energy source and rehydrating and regaining electrolytic balance before, during and after periods physical exertion and exercise and is fortified with solubilized Calcium, Iron, Vitamin B, C, D, and Prebiotic Fiber, which proves useful in providing essential vitamins and minerals to women who are physically active.

Said beverage comprises: purified water; carbohydrates (glucose, high fructose corn syrup or fructose corn syrup solids); aspartame (low-calorie artificial sweetner), and contains small amounts of salt; potassium chloride; calcium gluconate (calcium); ferric pyrophosphate, polyglycerol esthers, lecithin (iron); Vitamin B (helps the body convert carbohydrates into energy), ascorbic acid (vitamin C—promotes iron absorption); cholecalciferol (vitamin D3 promotes calcium absorption); prebiotic fiber (oligofructose, fructose, sprouted mung bean extract and acesulfame K—promotes vitamin B production and calcium absorption); natural and artificial flavors; and potassium sorbate (preserves freshness).

Since the presently claimed invention contains a number of different ingredients, it is important to understand the part played by each ingredient. Each of the important ingredients are explained herein.

Water—Water is the most important ingredient in the invention and in a sports beverage. Water serves to help replace lost fluids within the body and serves as a carrier for the carbohydrates and minerals necessary to aid the effectiveness of the beverage. Water also aids in regulating one's internal body temperature.

Water in the invention also solubalizes the ingredients during manufacture Water is present in the claimed invention at a total concentration of 97.3% weight percent.

Carbohydrates

Carbohydrates are present in the beverage of the invention as an energy source and to facilitate rehydration. In a preferred low-calorie, hypotonic beverage, high fructose corn syrup solids or liquids are used as the carbohydrate in the invention.

It should be noted that the carbohydrates used in the invention are present at a particular concentration in the beverage. While carbohydrates are necessary and beneficial as an energy source, absorption in the small intestine is slowed if the carbohydrate concentration is too high. Preferably the carbohydrate source for a low-calorie sports drink for pysically active women is present at a total concentration of 0.5-2% weight percent. Consequently, this is the approximate concentration of carbohydrate present in the presently claimed beverage.

Electrolytes—Several electrolytes are present in the low-calorie, hypotonic beverage to help replenish the minerals lost through sweat. These include sodium chloride, sodium benzoate, potassium chloride, and potassium sorbate. It should be noted that the sodium content helps stimulate people to drink more fluid voluntarily. This gives an advantage over water since voluntary consumption helps encourage a person to drink enough fluids to be adequately rehydrated. It is important to remember that thirst alone is a poor indicator of fluid needs. The human body becomes partially dehydrated even before any sense of thirst felt. Sodium also helps a person maintain body fluids whereas consuming plain water can actually trigger water loss by increasing urine production.

Vitamins and Minerals

Calcium—Essential for developing and maintaining healthy bones and teeth. Assists in blood clotting, muscle contraction, nerve transmission. Reduces risk of osteoporosis.

Iron—Needed for red blood cell formation and function.

Vitamin B—Essential for converting carbohydrates to energy. Needed for normal functioning of the nervous system and muscles, including heart muscle.

Vitamin C—Ascorbic Acid. Promotes healthy cell development, wound healing, resistance to infection. Serves as an antioxidant and promotes iron absorption.

Vitamin D—Aids in absorption of calcium, helps build bone mass and prevent bone loss. Helps maintain blood levels of calcium, phosphorus.

Prebiotic Fiber (Oligofructose, Fructose, Sprouted Mung Bean Extract and Acesulfame K) Soluble oligofructose is a non-digestible fiber that becomes a prebiotic, selective food source, to the “beneficial bacteria” (particularly Bifidobacteria and lactobacillus) of the large intestine. This supplementation helps provide B vitamins and helps in the improved absorption of calcium.

Citric Acid—Citric acid is present for several reasons.

First, it provides tartness to help balance the sweet taste resulting from the carbohydrates which may comprise high fructose corn syrup solids. It also helps give a clean mouth feel and also lowers the pH of the product, which aids in safe processing. Natural and Artificial Flavors—A variety of natural and artificial flavors are used in order to improve the flavor of the low-calorie, hypotonic beverage, and also help to encourage fluid intake.

Calcium and potassium lactate as a buffers.

Preservatives A small amount of sodium benzoate, potassium benzoate and potassium sorbate are used to preserve freshness.

Preferred Embodiments—One possible embodiment of the invention is created by adding purified water and natural and/or artificial flavorings to the dry ingredients listed below to create a finished sports drink beverage. These dry ingredients constitute Example #1.

### EXAMPLE #1

Ingredients Per 8 ounce serving Ingredient Weight Percent: High Fructose Corn Syrup or Corn Syrup Solids 0.63%, Aspartame 0.0003%, Calcium Lactate Gluconate (Calcium) 0.0011%, ferric pyrophosphate, polyglycerol esthers, lecithin (iron) 0.00007%, Vitamin B 0.003%, Ascorbic Acid (Vitamin C) 0.003%, cholecalciferol (vitamin D3) 0.0000012%, Prebiotic Fiber—Oligofructose, Fructose, Sprouted Mung Bean Extract and Acesulfame K 0.00001%, and preservatives in the fom of sodium benzoate, potassium benzoate and potassium sorbate.

Another possible embodiment involves Example #2 which is created by adding purified water and natural and/or artificial flavorings to the dry ingredients listed below to create a low-calorie, hypotonic sports drink concentrate.

### EXAMPLE #2

High Fructose Corn Syrup or Corn Syrup Solids 19.9%, Aspartame 0.42%, Calcium Lactate Gluconate (Calcium) 10.86%, ferric pyrophosphate, polyglycerol esthers, lecithin (iron) 0.08%, Vitamin B 0.04%, Ascorbic Acid (Vitamin C) 0.37%, cholecalciferol (vitamin D 0.00012%, r-Oligofructose, Fructose, Sprouted Mung Bean Extract and Acesulfame K 0.76%, Citric Acid 1.35%.

Method of Manufacture

In both examples, the dry ingredients are solubilized with water and mixed with a homo-mixer at >10 m/s, homogenized at >15 mPs and pasteurized utilizing commercial UV or alternative pasteurization methodologies.

The invention can be provided as either a finished beverage or sweetened concentrate. In the presweetened concentrate form it is reconstituted by admixing 3 oz of the concentrated composition with 20 ounces of water.

Test Results A 226 g (8 oz.) sample of the sports drink was tested for content. These results are given below:

Sodium 80 mg, ±0.8 mg,

Potassium 32 mg, ±0.5 mg,

Calcium 240 mg, ±2.4 mg,

Iron 1.5 mg , ±0.1 mg,

Vitamin D—60 mg, ±0.7 mg,

Ascorbic Acid—Vitamin C 60 mg, ±0.85 mg,

Vitamin D 40iu

Oligofructose 0.25 mg, ±0.02 mg

Total Carbohydrate 14 g, ±0.14 g,

Sugars 14 g, ±0.14 g Protein 0 g.

1. The drink is an low-calorie, hypotonic liquid composition sports beverage and sports beverage concentrate, fortified with Calcium, Iron, Vitamin B, Vitamin C, and Bitamin D, which is especially useful in rehydration and in providing an energy source as well as providing essential vitamins and minerals to physically active women before, during, or after periods of physical activity:

2. The beverage of claim 1 wherein the carbohydrate source is present at a total concentration in a single serving of 1.4 grams.

3. The beverage of claim 2 wherein the carbohydrate source comprises high fructose corn syrup or corn syrup solids.

4. The beverage of claim 1 wherein the low-calorie sugar substitute comprises aspartame.

5. The beverage of claim 1 wherein the electrolyte comprises a group consisting of sodium chloride ions (80 mg) and potassium chloride ions (30 mg) and minor amounts of sodium benzoate, potassium sorbate or potassium phosphate as preservatives.

6. The beverage of claim 1 further comprising a source of Vitamin C wherein said source provides 100 percent of the daily requirement of 60 mg per serving.

7. The beverage of claim 1 further comprising a source of Calcium wherein said source provides 20 percent of the daily requirement of 1200 mg per serving.

8. The beverage of claim 1 further comprising a source of Vitamin B wherein said source provides 10 percent of the daily requirement of 60 mg per serving.

9. The beverage of claim 1 further comprising a source of Iron wherein said source provides 10% percent of the daily requirement of 15-18 mg per serving.

10. The beverage of claim 1 further comprising a source of Vitamin D wherein said source provides 20 percent of the daily requirement of 200 iu per serving.

11. The beverage of claim 1 further comprising a source of prebiotic fiber as soluble oligofructose that becomes a selective food source in the large intestine.

12. The beverage of claim 1 further comprising natural and artificial flavors and artificial or natural color.

13. The concentrate of claim 1 wherein said concentrate is in the form of a syrup suitable for constituting with water to form a final beverage for oral administration of water, physiologically essential electrolytes, nutrient minerals, and carbohydrates to a human body.
